(19) United States
(12) Patent Application Publication
(10) Pub. No.: US 2005/0121937 A1
(43) Pub. Date: Jun. 9, 2005

(54) Collapsible cover for a vehicle

(76) Inventor: Bryan Hudgins, San Diego, CA (US)

Correspondence Address: DAVID R PRESTON & ASSOCIATES, 12625 HIGH BLUFF DRIVE, SUITE 205, SAN DIEGO, CA, 92130, US

(21) Appl. No.: 10/993,181

(22) Filed: Nov. 19, 2004

Related U.S. Application Data
(60) Provisional application No. 60/524,309, filed on Nov. 21, 2003.

(51) Int. Cl. B60J 11/00

(52) U.S. Cl. 296/98; 296/136.01

(57) ABSTRACT

The present invention includes a collapsible vehicle including a protective cover able to substantially cover a vehicle, a base and optionally a spindle and capsule top. An attachment structure is capable of attaching the protective cover to the base or spindle. The collapsible cover may be manually operated or may be remotely operated by a suitable remote control unit, sensor or activator.

### CROSS REFERENCE TO RELATED APPLICATIONS

The present application claims benefit of priority to U.S. patent application Ser. No. 60/524,309 entitled, “Collapsible Automobile Cover”, filed on Nov. 21, 2003 and is herein incorporated by reference in its entirety

### TECHNICAL FIELD

The present invention relates generally to vehicle coverings, and more specifically to a collapsible cover for a vehicle.

### BACKGROUND OF THE INVENTION

Covers for vehicles such as automobiles, motorcycles and boats are widely available. However storage of these devices can be quite cumbersome. Storing a currently available vehicle cover typically involves removing the cover from the vehicle then rolling or folding the cover for storage in the trunk or garage. The present invention addresses these shortcomings and provides related and added benefits.

### SUMMARY

In one aspect of the present invention a collapsible cover for a vehicle is disclosed including a protective cover able to substantially cover a vehicle and a base including an attachment structure and a storage groove. The attachment structure attaches the protective cover to the base and the storage groove provides a surface such as generally about the perimeter of the base in which the protective cover may be wrapped, stored or collapsed.

In another aspect of the present invention a collapsible cover is disclosed including a protective cover able to substantially cover a vehicle, a base, a spindle and an attachment structure. The protective cover is attached to the spindle or base via the attachment structure and may be wrapped, stored or collapsed around the spindle.

In other aspects of the present invention, methods of producing a collapsible cover, methods of using a collapsible and novel components of the collapsible cover are also disclosed.

### BRIEF DESCRIPTION OF THE DRAWINGS

FIG. 1 depicts a collapsible cover 10 of the present invention including a base 11, an attachment structure 12 and a protective cover 13. FIG. 1A is an elevated front right view depicting the base 11 and attachment structure 12. FIG. 1B is an elevated front right view depicting the protective cover 13 attached to the attachment structure 12.

FIG. 2 is a front plan view depicting an alternative embodiment of the collapsible cover 10. The collapsible cover 10 is shown in the open position without the protective cover 13. The base 11 is shown with a spindle 14 extending generally upwards and joined to the capsule top 15 by a joining structure 16 such as a screw. An attachment structure 12 in the form of a machined slit is positioned along the spindle 14. The depicted spindle 14 is optionally rotatable allowing the user to wrap the protective cover 13 about the spindle 14. Raised rubber knobbles 16 are shown positioned about the base 11 and facilitate the closure of the capsule top 15 to the base 11.

FIG. 3 is a front plan view depicting a collapsible cover 10 of the present invention in the closed and stored position. The capsule top 15 is shown in contact with the base 11.

FIG. 4 is an elevated front right view of the collapsible cover 10 depicting the protective cover 13 substantially covering an automobile. The collapsible cover 10 is shown positioned on the roof of the automobile in the open position exposing the spindle 14 and attachment structure 12. The protective cover 13 drapes substantially over the automobile and includes a tightening means 17 in the form of a sewed in nylon rope with integrated tightening clamp.

FIG. 5 is an elevated front right view depicting a collapsible cover 10 of the present invention in the closed position. The protective cover 13 substantially covers the automobile and the capsule top 15 is closed to further retain the protective cover 13.

FIG. 6 is an elevated front right view of a collapsible cover 10 having a motorized rotating means 18. The motorized rotating means 18 rotates the spindle 14, which is rotatably mounted to the capsule top 15 such as at the joining structure 16. The spindle 14 including the attachment structure 12 is shown integrated with the motorized rotating means 18. The motorized rotating means 18 is housed in the base 11 and an aperture permits the spindle 14 to extend from the base 11.

FIG. 7 is a cutaway plan view from beneath the capsule top 15 further demonstrating storage of a protective cover 13, a spring loaded collapsible spindle 14 is joined at the joining structure 16 to the inner and uppermost region of the capsule top 15 and may provide a surface in which the protective cover 13 may wrap around. The protective cover 13 may then be stored within the capsule top 15.

### BRIEF DESCRIPTION OF THE INVENTION

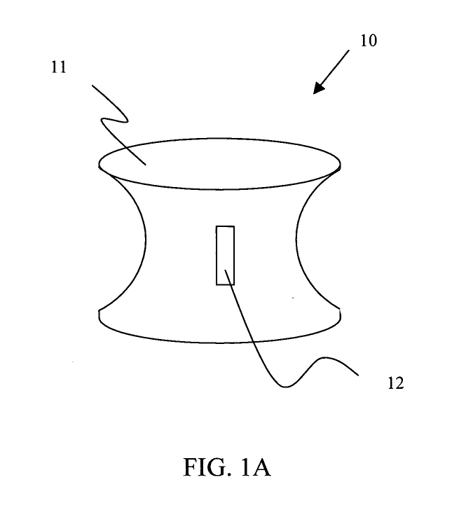

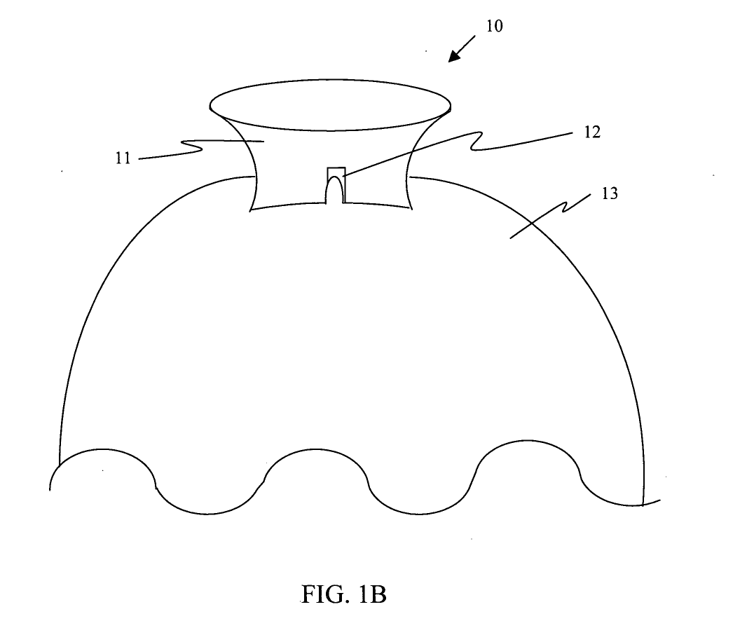

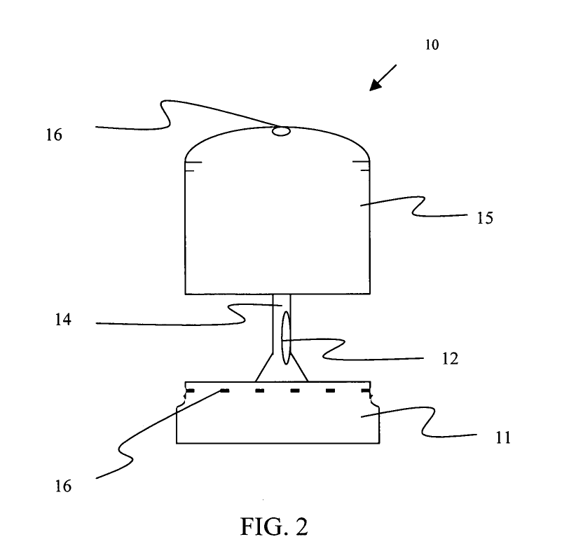

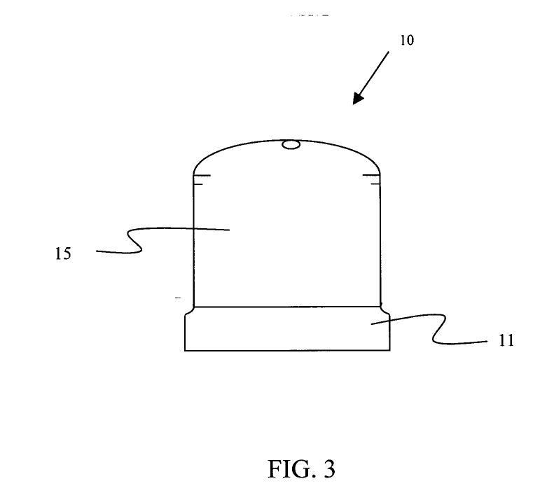

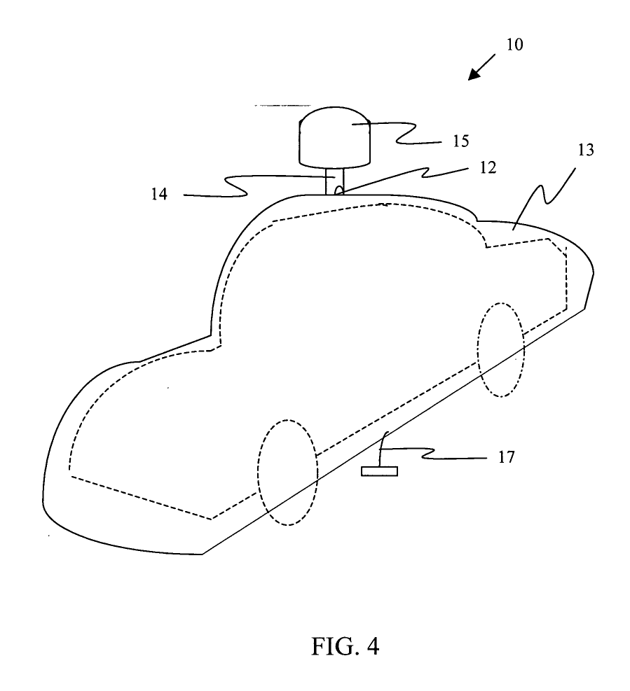

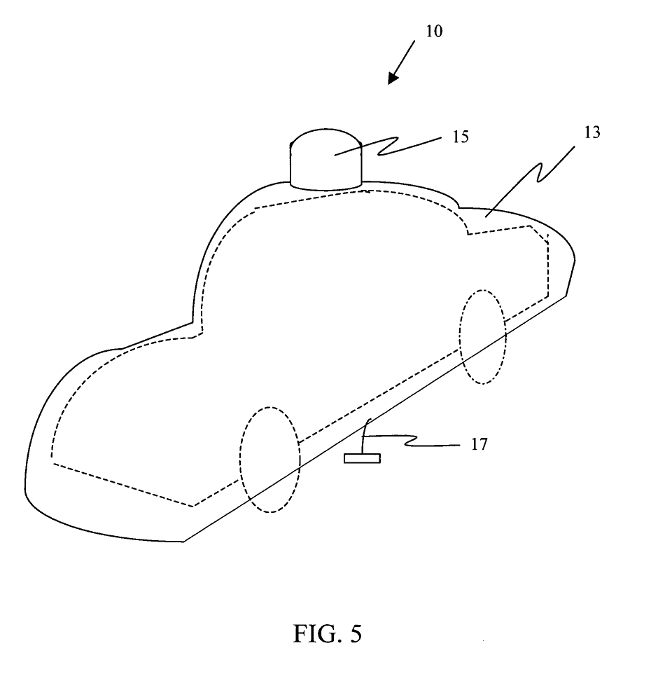

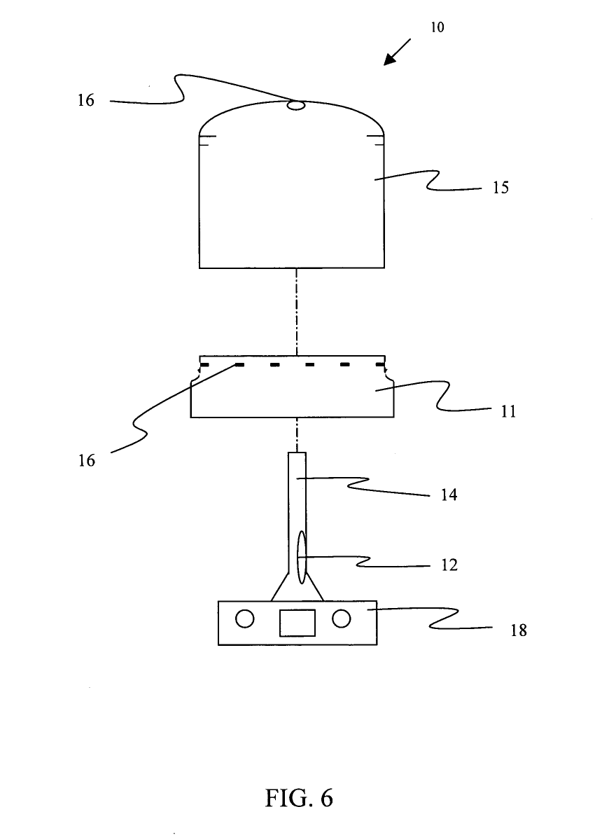

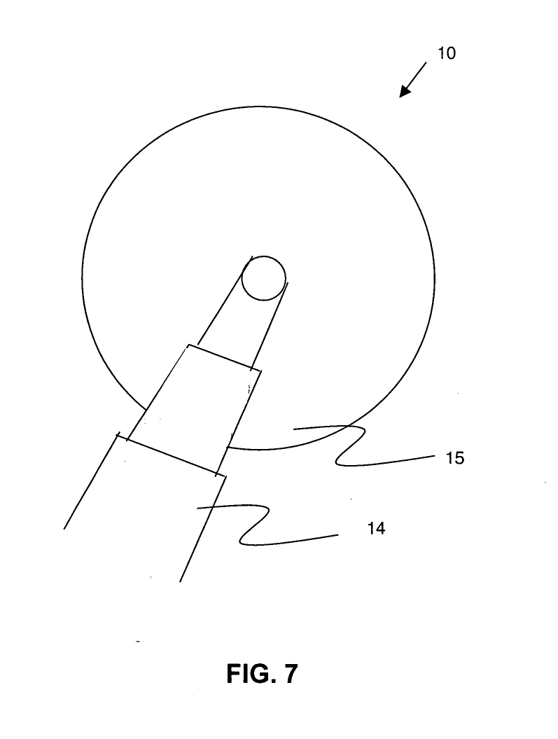

Referring to FIGS. 1-7, in one aspect of the present invention a collapsible cover for a vehicle is provided including a protective cover 13 able to substantially cover a vehicle, and a base 11 including an attachment structure 12 and a storage groove. The attachment structure 12 attaches the protective cover 13 to the base 11 and the storage groove provides a surface to wrap and thereby store or collapse the protective cover 13.

Other aspects and embodiments of present invention include a protective cover 13, a base 11, an attachment structure 12 and a spindle 14. The attachment structure 12 attaches the protective cover 13 to the base 11 or spindle 14 and the spindle 14 provides a surface to wrap and thereby assist in the storage or collapsing of the protective cover 13. The present invention optionally includes a capsule top 15 capable of covering the protective cover 13 when wrapped around the base 11 or spindle 14.

The present invention may be used with a variety of vehicles. For example, the present invention may be used with an automobile, a truck, a motorcycle, a boat, a personal watercraft such as Sea-Doo or Jet Ski, a snowmobile and the like.

The protective cover 13 protects the vehicle from external elements or conditions. For example the protective cover 13 may protect an automobile from a variety of elements such as but not limited to sun, snow, heat, cold, rain, animal excrements such as bird excrements, tree sap, pollen, salt air, and spills. The protective cover 13 may therefore be substantially weather or stain resistant or coated with a weather or stain resistant material. The protective cover 13 may be created from any spectrum of desired fabric. The protective cover 13 may be treated or untreated with any suitable chemical, liquid substance and the like to obtain the desired characteristics. The fabric may include one or more laminate layers. For example, the protective cover 13 may be constructed materials such as but not limited to nylon, polyester, gortex, cotton, parachute fabric, a combination thereof and the like. The protective cover 13 may be constructed from a blend of materials. The protective cover 13 may be constructed from a lightweight, washable material.

The protective cover 13 may be reflective or nonreflective. A reflective protective cover 13 may reflect heat or light inward by providing a reflective inner surface or may reflect light or heat outward by providing a reflective outer surface. Reflective surfaces, materials or coatings used in the construction of sunshades or metalized films may be used or incorporated in the present invention.

The protective cover 13 may attach to the base 11 or spindle 14 via an attachment structure 12. The protective cover 13 may include one or more attachment sites having a surface complementary to and capable of interlocking with the attachment structure 12. Alternatively, the protective cover 13 may attach by sliding a portion of the cover through an attachment structure 12 such as a slit. The protective cover 13 may attach to any suitable region such as generally about the center portion of the protective cover 13 such that when the collapsible cover is affixed to a central portion of a vehicle such as a roof of an automobile the protective cover 13 drapes generally downward about the vehicle. In some configurations the protective cover 13 may have an aperture through which a portion of the base 11 or spindle 14 may be placed and attached. Alternatively, there is no aperture. However, the protective cover 13 may attach away from the center portion. This embodiment may be desired if the collapsible cover is affixed to an end region of an automobile such as on the top of the hood or trunk or along the side.

The size of the protective cover 13 may vary depending on the size of the vehicle to be protected. The protective cover 13 substantially covers a vehicle and therefore should be sized so that it drapes over the top of the vehicle. In alternate embodiments the protective cover 13 is provided such that the protective cover 13 nearly contacts or contacts the ground surface. A protective cover 13 for a motorcycle would likely be smaller that the protective cover 13 for an automobile. Similarly, the size and shape of the protective cover 13 may vary depending on the particular vehicle such as make and model of an automobile or motorcycle. Thus the protective cover 13 disclosed in present invention may be provided in a variety of sizes and shapes.

The protective cover 13 may include a tightening means such as a sewn in nylon drawstring cord positioned about the perimeter to facilitate tightening of the protective cover 13 along the lower portion of the vehicle. A tightening clamp may be used to reversibly clamp a tightened cord. Alternative configurations may utilize snaps, Velcro (R), hook and loop and the like to adjust the size of the outer perimeter after substantially covering the vehicle.

The capsule base 11 may provide a storage surface for the protective cover 13 by including a storage groove, may have a spindle 14 projecting generally upward or may house a rotating means 18 such as a motor able to rotate the base 11 or spindle 14. The base 11 may be configured in any shape or configuration.

In one embodiment the base 11 is configured in a generally disc-like or cylindrical shape having a storage groove generally about the perimeter or along the circumference of the cylinder. The storage groove may function as a guide when wrapping the protective cover 13 and may assist in retaining a stored protective cover 13 by preventing or reducing sliding of the protective cover 13 from the base 11. The attachment means may be positioned within the storage groove. The base 11 may be substantially hollow allowing the base 11 to house a rotating means 18 such as a motor.

In another embodiment the base 11 is configured generally cubic in shape having a spindle 14 extend generally upward. The base 11 may or may not house a rotating means 18 such as a motor to rotate the spindle 14. In this embodiment the base 11 may assist in storing the collapsed protective cover 13 by providing a lower surface for the protective cover 13 to contact.

The base 11 may be constructed from a variety of rigid or semi-rigid materials such as but not limited to molded plastic or metal. Injection molded plastic such as polypropylene or polystyrene may be formed into a base 11 by using injection-molding techniques known in the mechanical arts.

The size of the base 11 may vary depending on the protective cover 13 used as well as the base 11 configuration. As general guidance the base 11 may have a diameter or distance across opposing sides of about less than four, four, six, eight twelve, fifteen, twenty, twenty-four, thirty-six inches or more or less. The vertical height may also vary and may be about less than one inch, one, four, eight, twelve, fifteen, twenty inches or more or less. Thus, the size of the base 11 may differ depending on the vehicle size or configuration.

The base 11 may also provide an affixing structure allowing the collapsible storage cover such as a base 11 portion to be affixed or reversibly affixed to the vehicle. The base 11 may be affixed at any point so long as the protective cover 13 can substantially cover the vehicle when in the open position, but preferably the base 11 is affixed to the uppermost portion of the vehicle such as an automobile roof. However the present invention includes an affixing structure that affixes the present invention to any outer part of the vehicle such as on top of a trunk, hood, along the side of a vehicle and the like. When used with vehicles such as a motorcycle or a snowmobile, the present invention may be affixed to the gas tank, to the handle bars, or the like. Examples of appropriate affixing structures include but are not limited to a magnet, a suction cup, a clasp, a clamp or a strap. The affixing structure may further include a protective surface such as a pad to prevent potential scratching of the vehicle. Alternatively the affixing means may affix the base 11 to an automobile rack such as those offered by automobile manufactures or aftermarket producers such as Yakima and Thule. Preferably the affixing structure allows the present invention to be reversibly affixed or removable.

The attachment structure 12 attaches the protective cover 13 to the base 11 or spindle 14. The attachment structure 12 may be formed using a variety of attachment techniques such as but not limited to a slot or a clasp allowing a top portion of the protective cover 13 to slide through or be clasped by the attachment structure 12. The attachment structure 12 may incorporate a slot with rubber knobules to prevent extensive slipping of the protective cover 13 from the slot. Alternatively the attachment structure 12 may snap, button or hook the protective cover 13. The protective cover 13 may have surfaces complementary to the attachment structure 12 such that they interlock. Examples of such surfaces are snaps, Velcro (R), hook and loop, and the like. The protective cover 13 may be reinforced at points or regions in contact with the attachment structure 12 to reduce stress placed on the protective cover 13. The attachment structure 12 may be positioned on a portion of the base 11, within a storage groove or may be positioned on a structure such as a spindle 14 extending generally upward from the base 11. The attachment structure 12 may be attach the protective cover 13 to a portion along the length of the spindle 14 or at the uppermost region such as at a joining structure 16. The attachment structure 12 may reversibly or irreversibly attach the protective cover 13.

The present invention may further include a spindle 14 to facilitate the storage of the protective cover 13. The spindle 14 may provide a surface in which the attachment structure 12 may be positioned or may provide a surface in which the protective cover 13 may wrap around. The spindle 14 may be a rigid structure in a fixed configuration or may be collapsible. The spindle 14 may be constructed from a variety of materials such as molded plastics, resigns and the like. As non-limiting examples, the spindle 14 may be constructed using injection molding techniques known in the plastic arts and may constructed from materials such as but not limited to polypropylene and polystyrene or derivatives or combinations thereof. The spindle 14 may be attached to a capsule top 15 such as by a joining structure 16 and may allow the capsule top 15 to turn freely, may lock, may restrict the turning or may be detachable from the capsule top 15.

The size of the spindle 14 may vary depending on the size of the protective cover 13. A taller spindle 14 may allow the diameter or distance between opposing sides of the present invention to be smaller since a taller spindle 14 may provide an additional surface for a protective cover 13 to wrap around. For example, the spindle 14 may be less than four inches, about four inches, about eight inches, about twelve inches or more or less.

In one configuration, the spindle 14 is a spring-loaded collapsible spindle 14 incorporating an attachment structure 12. The spindle 14 may partially collapse upon the closing of the capsule top 15 and may extend generally upward upon the removal or opening of the capsule top 15. The upward extension may be performed by a force exerted from a compressed spring or may be performed by lifting the capsule top 15 generally upward. The spindle 14 may include a plurality of sections that progressively decrease or increase in diameter thereby allowing the spindle 14 to extend or collapse. The spindle 14 may host the attachment structure 12 such as one or more machined slots extending vertically. A portion of the protective cover 13 may be fed through one or more machined slots such that the protective cover 13 is not inadvertently unattached from the machined slots.

The spindle 14 may be joined to a capsule top 15 at the uppermost region of the spindle 14. The spindle 14 may be joined to the capsule top 15 by a joining structure 16 such as a complementary surface, a screw top or screw-like structure, a pin and groove-like structure and the like. The spindle 14 may be rotatably joined to the capsule top 15 or fixedly joined to the capsule top 15. The attachment structure 12 may be incorporated as part of the joining structure 16 such that the protective cover 13 is attached to the spindle 14 along the uppermost region of the spindle 14.

The spindle 14 may be nonrotatable or rotatable with a locking position allowing the user to manually wrap the protective cover 13 generally about the spindle 14. Alternatively a spindle 14 may be rotatable allowing the user to rotate the spindle 14 instead of the protective cover 13. Rotating a spindle 14 may be performed manually or automatically. A rotating means 18 such as a motor may be used in the present invention to rotate the spindle 14. The spindle 14 may be integrated as a single unit with the rotating means 18 such as a remote control motor such that the spindle 14 slides through an aperture positioned about the center of the base 11 or may be reversibly interlock with a complementary surface of the rotating means 18.

The present invention may include a capsule top 15 able to encase or protect the protective cover 13 when in the stored or wrapped position. The capsule top 15 may cover the storage groove or spindle 14 within a cavity. The capsule top 15 may be provided in a variety of shapes and sizes able to encase or protect the protective cover 13. The capsule top 15 may be generally semi-spherical, cubic, rectangular, pentagonal, octagonal and the like. The capsule top 15 may be removable from the base 11 or spindle 14. The capsule top 15 may be may be free to pivot, turn, rotate or lock into place. The capsule top 15 may be fastened to the base 11 or spindle 14 using a variety of techniques known in the fastening industries such as but not limited to screw and thread, interlocking complimentary surfaces, fasteners and the like. The capsule top 15 may be locked to the base 11 in the closed position by incorporating rubber knobules such as ring knobules, or locks such as twist locks. The opening and closing a the capsule top 15 may be performed manually or by a remote control motor able to raise or lower the capsule top 15 such as by elevating or lowering the spindle 14.

The capsule top 15 may be constructed from a variety of materials such as injection molded plastic, polypropylene, polystyrene, resigns and the like or may be constructed from a material such as a glass and the like. The capsule top 15 may be opaque or transparent. The capsule top 15 may include an illuminating means such as a low voltage light source and may emit a variety of colors or hues. The illuminating light source may emit a glow, a broad light beam or a focused beam such as a laser beam. The capsule top 15 may therefore have a glowing appearance upon activation of the light source or may display one or more distinct light beams such as a laser beam reflecting about the inner portion of the capsule top 15.

The capsule top 15 or base 11 may also include a transportation structure such as a carrying handle to facilitate the transportation of the present invention. For example, a handle may be positioned generally about the top of the capsule cover allowing the user to move, transport or adjust the position of the present invention. The handle may include a trigger structure that locks the capsule top 15 to the base 11 thereby reducing the likelihood of the present device opening during transport.

The capsule top 15 or base 11 may also include an operating structure positioned at a point along the capsule top 15 or region that facilitates at least one operation during the opening or closing of the present invention. The operating structure may assist in closing, locking or opening the device and the like.

The present invention may also include a rotating means 18 able to rotate the spindle 14 or base 11. The rotating means 18 may be provided in the form of a motor with or without a remote control. The rotating means 18 may rotate the spindle 14 or base 11 in one direction such to wrap the protective cover 13 for storage or to unwrap the protective cover 13 or may rotate in two opposing directions such to wrap and unwrap the protective cover 13. The rotating means 18 may be housed in the base 11 such that it is not easily viewed. The rotating means 18 may be remotely controlled by a remote control unit having a push button able to activate a remote sensor and may be provided on the same remote control unit as an alarm such as a car alarm remote control unit. The rotating means 18 may be activated while a button is depressed and stop once the push button is release or may continue to rotate for a predetermined or preprogrammed time. The rotating means 18 may be powered by any available power source such as rechargeable or nonrechargeable batteries, a cigar lighter and the like.

The rotating means 18 may include a sensor able to activate rotation of the base 11 or spindle 14. The sensor may be activated by incorporating one or more direct control technologies such as pushing a button positioned on the base 11 unit or inserting a key in an appropriate aperture and optionally turning the key in one or more directions. Alternatively the sensor may activate rotation upon receiving a remote signal such as those utilized in the remote control technologies, wireless technologies, infrared technologies and the like.

In one embodiment the rotating means 18 rotates the base 11. In this embodiment the rotating means 18 is generally fixed in position such as affixed to a vehicle and rotatably mounted to the base 11. Upon activation, the rotating means 18 spins the base 11.

In another embodiment a motor rotating means 18 rotates the spindle 14. In this configuration the motor is nonrotatably housed in the base 11 such that the base 11 does not substantially rotate. The spindle 14 is rotatably connected to the motor such that when the motor is activated such as by pushing the push button on a remote control, the spindle 14 may rotate.

In other aspects of the present invention, one or more novel components of the collapsible cover are disclosed. Thus, the present invention may include one or more of the disclosed rotating means or structures, one or more remote control units, hardware, hardwire, one or more wireless devices, one or more of the disclosed protective covers, and the like.

### EXAMPLES

### Example I

### Installation of a Collapsible Automobile Cover Having a Protective Cover, Base, Spindle, Attachment Structure and Capsule Top

Place the collapsible automobile cover on top of the vehicle. Open the capsule top such as by turning and raising the capsule top in an open position. Grasp the protective cover such as with two fingers and walk around the vehicle allowing the fabric to flow over and substantially cover the vehicle. Pull the tightening cord and lock into desired tightness generally around the tires. Re-lock or close the capsule top if desired on a windy day.

### Example II

### Collapsing a Collapsible Automobile Cover Having a Protective Cover, Base, Spindle, Attachment Structure and Capsule Top

Unlock and raise the capsule cap, loosen the tightening cord, and take protective cover in two fingers. Walk around the vehicle turning the fabric around the spindle. Tuck the remaining portion of the protective cover under the capsule cap. Close and lock the capsule top to the base. Detach the base from the automobile and put away.

All headings are for the convenience of the reader and should not be used to limit the meaning of the text that follows the heading, unless so specified.

1. A collapsible cover for a vehicle comprising:
a) a protective cover able to cover a vehicle;
b) a base comprising:
i) an attachment structure capable of attaching said protective cover; and
ii) a storage groove positioned generally about the perimeter of said base, further wherein said protective cover may be wrapped around said storage groove.

2. The collapsible cover according to claim 1, wherein said protective cover is constructed from a material selected from the group consisting of nylon, gortex, cotton, parachute fabric, polyester, or a combination thereof.

3. The collapsible cover according to claim 1, wherein said protective cover is water resistant.

4. The collapsible cover according to claim 1, wherein said protective cover comprises a reflective material.

5. The collapsible cover according to claim 1, wherein said vehicle is selected from the group consisting of an automobile, a truck, a motorcycle, a boat, a personal watercraft and a snowmobile.

6. The collapsible cover according to claim 1, wherein said base is constructed from a plastic or plastic polymer.

7. The collapsible cover according to claim 1, wherein said attachment structure is selected from the group consisting of a slit, a snap, a hook, a loop, a button and Velcro (R).

8. The collapsible cover according to claim 1, wherein said attachment structure and said protective cover comprise complementary interlocking surfaces.

9. The collapsible cover according to claim 1, wherein said attachment structure reversibly attaches said protective cover.

10. The collapsible cover according to claim 1, wherein said protective cover further comprises a tightening means positioned generally about the bottom of said protective cover able to tighten said protective cover generally about the lower portion of said vehicle.

11. The collapsible cover according to claim 10, wherein said tightening means comprises a drawstring and a tightening clamp.

12. The collapsible cover according to claim 1, further comprising a capsule top capable of accepting said base, wherein said capsule top is capable of encasing said protective cover wrapped around said storage groove.

13. The collapsible cover according to claim 1, wherein said base further comprises an affixing structure able to affix said base to a vehicle.

14. The collapsible cover according to claim 13, wherein said affixing structure is a magnet or a suction cup.

15. The collapsible cover according to claim 1, further comprising a rotating means able to rotate said base.

16. The collapsible cover according to claim 15, wherein said rotating means comprises a remote control motor.

17. A collapsible cover with integrated storage housing comprising:
a) a protective cover able to substantially cover a vehicle;
b) a base;
c) a spindle, wherein said protective cover is capable of wrapping around said spindle; and
d) an attachment structure capable of attaching said protective cover to said spindle or said base.

18. The collapsible cover according to claim 17, wherein said base further comprises an affixing structure able to affix said base to a vehicle.

19. The collapsible cover according to claim 17, wherein said base comprises a rotating means capable of rotating said spindle.

20. The collapsible cover according to claim 19, wherein said rotating means is a motor able to be remotely controlled.

21. The collapsible cover according to claim 17, further comprising a capsule top able to encase said protective cover when wrapped around said spindle.
